(19) United States
(12) Patent Application Publication
(10) Pub. No.: US 2014/0098674 A1
(43) Pub. Date: Apr. 10, 2014

(54) COMMUNICATION SYSTEM, CONTROL DEVICE, AND PROCESSING RULE SETTING METHOD AND PROGRAM

(71) Applicant: NEC Corporation, Tokyo (JP)

(72) Inventors: Kentaro Sonoda, Tokyo (JP); Hideyuki Shimonishi, Tokyo (JP); Masayuki Nakae, Tokyo (JP); Masaya Yamagata, Tokyo (JP); Yoichiro Morita, Tokyo (JP)

(73) Assignee: NEC Corporation, Tokyo (JP)

(21) Appl. No.: 14/124,220

(22) PCT Filed: Jun. 1, 2012
(86) PCT No.: PCT/JP2012/003632

§ 371 Date: Dec. 5, 2013

(30) Foreign Application Priority Data
Jun. 6, 2011 (JP) 2011-125954

(51) Int. Cl. H04L 12/803; H04L 12/727; H04L 12/26

(52) U.S. Cl. CPC H04L 47/125; H04L 43/0882; H04L 45/121
USPC 370/238; 370/410; 370/235

(57) ABSTRACT

A communication system includes: a plurality of forwarding nodes that process a packet transmitted from a user terminal, in accordance with a processing rule that has been set, and a control device that selects a forwarding node in which a processing rule is to be set, from among the plurality of forwarding nodes, such that processing rules are set so as not to be concentrated in a specific forwarding node, based on the number of processing rules that are set in each of the forwarding nodes.

### TECHNICAL FIELD

### REFERENCE TO RELATED APPLICATION

This application is based upon and claims the benefit of the priority of Japanese patent application No. 2011-125954, filed on Jun. 6, 2011, the disclosure of which is incorporated herein in its entirety by reference thereto. This invention relates to a communication system, a control device, and a method and computer program for setting a processing rule, and in particular to a communication system, a control device, and a method and computer program for setting a processing rule, in which the control device centrally controls forwarding nodes disposed in a network.

### BACKGROUND ART

Recently, technology referred to as OpenFlow has been proposed (refer to Patent Literature 1, and Non-Patent Literatures 1 and 2). In OpenFlow, communication is treated as end-to-end flow, and path control, recovery from failure, load balancing and optimization are performed in flow units. An OpenFlow switch as specified in Non-Patent Literature 2 is provided with a secure channel for communication with an OpenFlow controller positioned as a control device, and operates according to a flow table in which appropriate addition or rewriting is instructed by the OpenFlow controller. In the flow table are definitions of sets of matching rules (Header fields) for collation with packet headers, flow statistical information (Counters), and actions (Actions) defining processing content, for each flow (refer to FIG. 13).

For example, when an OpenFlow switch receives a packet, an entry is searched for that has a matching rule (refer to header fields in FIG. 13) that matches header information of the received packet, from the flow table. As a result of the search, in a case where an entry matching the received packet is found, the OpenFlow switch updates the flow statistical information (Counters) and also implements processing content (packet transmission from a specified port, flooding, dropping, and the like) described in an Actions field of the entry in question, for the received packet. On the other hand, as a result of the search, in a case where an entry matching the received packet is not found, the OpenFlow switch forwards the received packet to the OpenFlow controller via a secure channel, requests determination of a path of the packet based on source and destination of the received packet, receives a flow entry realizing this, and updates the flow table. In this way, the OpenFlow switch uses the entry stored in the flow table as a processing rule to perform packet forwarding.

### CITATION LIST

### Patent Literature

[PTL 1]
WO Pamphlet No. WO2008/095010

### Non-Patent Literature

[NPL 1]
Nick McKeown, and 7 others, “OpenFlow: Enabling Innovation in Campus Networks”, [online] [search conducted May 26, 2011] Internet URL:
<http://www.openflow.org/documents/openflow-wp-latest.pdf>
[NPL 2]
“OpenFlow Switch Specification” Version 1.1.0. Implemented (Wire Protocol 0x02), [search conducted May 26, 2011] Internet URL:
<http://www.openflow.org/documents/openflow-spec-v1.1.0.pdf>

### SUMMARY OF INVENTION

### Technical Problem

The entire disclosures of the abovementioned Patent Literature 1 and Non-Patent Literatures 1 and 2 are incorporated herein by reference thereto. The following analysis is given according to the present disclosure. An OpenFlow controller as described in Patent Literature 1 refers to a policy file when a new flow is generated, to perform a permission check, and thereafter performs access control by calculating a path (Patent Literature 1, [0052]).

In a case of a configuration of Patent Literature 1, assuming that several thousand user terminals, servers and databases are connected in a network of relatively large scale configured by several dozen to several hundred forwarding nodes, such as OpenFlow switches and the like, a large quantity of flow entries (processing rules) realizing communication between these user terminals and various types of resources is necessary. At this time, there is a possibility that the number of flow entries (processing rules) that are set in some of the forwarding nodes will exceed the quantity allowed in the relevant forwarding nodes. Furthermore, in the case of a configuration of Patent Literature 1, there is a possibility that processing load of each of the forwarding nodes will increase, and a problem will occur in operation of the network.

That is, in the configuration of Patent Literature 1 there is a problem in that management of setting destinations of the flow entries (processing rules) is not realized. Furthermore, much time and troubles will be involved when a human network manager sets this large quantity of flow entries (processing rules) in the forwarding nodes.

It is an object of the present disclosure to provide a communication system, method and computer program for setting a flow entry (processing rule) in an appropriate forwarding node, such that processing rules are not excessively concentrated in the respective forwarding nodes.

### Solution to Problem

According to a first aspect of the present disclosure there is provided a communication system, comprising: a plurality of forwarding nodes that process a packet(s) transmitted from a user terminal, in accordance with a processing rule(s) that has been set; and at least one control device which, when a processing rule that can be set in any among the plurality of forwarding nodes is set, selects a forwarding node in which the processing rule is to be set, from among the plurality of forwarding nodes, such that processing rules are not concentrated in a specific forwarding node, based on the number of processing rules that are set in each of the forwarding nodes.

According to a second aspect of the present disclosure there is provided a control device, adapted to be connected to a plurality of forwarding nodes that process a packet(s) transmitted from a user terminal, in accordance with a processing rule(s) that has been set. When a processing rule(s) that can be set in any among the plurality of forwarding nodes is set, a selection is made of a forwarding node(s) in which the processing rule is to be set, from among the plurality of forwarding nodes, such that processing rules are not concentrated in a specific forwarding node(s), based on the number of processing rules that are set in the respective forwarding nodes.

According to a third aspect of the present disclosure there is provided a processing rule setting method, comprising: a step wherein a control device, adapted to be connected to a plurality of forwarding nodes that process a packet(s) transmitted from a user terminal, in accordance with a processing rule(s) that has been set, confirms the number of processing rules that are set in the respective forwarding nodes, when a processing rule(s) that can be set in any among the plurality of forwarding nodes is set; and a step wherein the control device selects a forwarding node in which the processing rule(s) is to be set, from among the plurality of forwarding nodes, such that processing rules are not concentrated in a specific forwarding node(s), based on the number of processing rules that are set in the respective forwarding nodes, and sets the processing rule in the forwarding node(s). The present method is linked with a specific apparatus, known as a control device that controls the forwarding nodes.

According to a fourth aspect of the present disclosure there is provided a program for executing in a computer consisting a control device, adapted to be connected to a plurality of forwarding nodes that process a packet(s) transmitted from a user terminal, in accordance with a processing rule(s) that has been set, the program executing: a process of confirming the number of processing rules that are set in the respective forwarding nodes, when a processing rule(s) that can be set in any among the plurality of forwarding nodes is set; and a process of selecting a forwarding node in which the processing rule(s) is to be set, from among the plurality of forwarding nodes, such that processing rules are not concentrated in a specific forwarding node(s), based on the number of processing rules that are set in the respective forwarding nodes, and setting the processing rule in the forwarding node(s). It is to be noted that that this program can be recorded on a computer-readable storage medium which may be non-transient. That is, the present disclosure can be embodied as a computer program product.

### Advantageous Effects of Invention

According to the present disclosure, it is possible to arrange such that processing rules are not concentrated in a specific forwarding node or nodes, among a plurality of forwarding nodes.

### BRIEF DESCRIPTION OF DRAWINGS

FIG. 1 is a diagram for describing an outline of an exemplary embodiment of the present disclosure;

FIG. 2 is a diagram representing a configuration of a processing rule management system of a first exemplary embodiment.

FIG. 3 is an example of authentication information held in an authentication device in the first exemplary embodiment;

FIG. 4 is an example of communication policy information stored in a communication policy storage unit of the first exemplary embodiment;

FIG. 5 is an example of resource information stored in a resource information storage unit of the first exemplary embodiment;

FIG. 6 is an example of a communication policy communicated to a control device from a policy management device of the first exemplary embodiment;

FIG. 7 is a block diagram representing a detailed configuration of a control device of the first exemplary embodiment;

FIG. 8 is a sequence diagram representing a sequence of operations of the first exemplary embodiment;

FIG. 9 is a diagram for describing processing of selecting a setting destination of a processing rule by a control device of the first exemplary embodiment;

FIG. 10 is an example of a threshold set for respective forwarding nodes of FIG. 9;

FIG. 11 is a flowchart representing flow of processing of selecting a setting destination of a processing rule by a control device of the first exemplary embodiment;

FIG. 12 is a diagram for describing processing of selecting a forwarding node as a setting destination of a processing rule by a control device of a second exemplary embodiment of the present disclosure; and

FIG. 13 is a diagram representing a configuration of a flow entry described in Non-Patent Literature 2.

### DESCRIPTION OF EMBODIMENTS

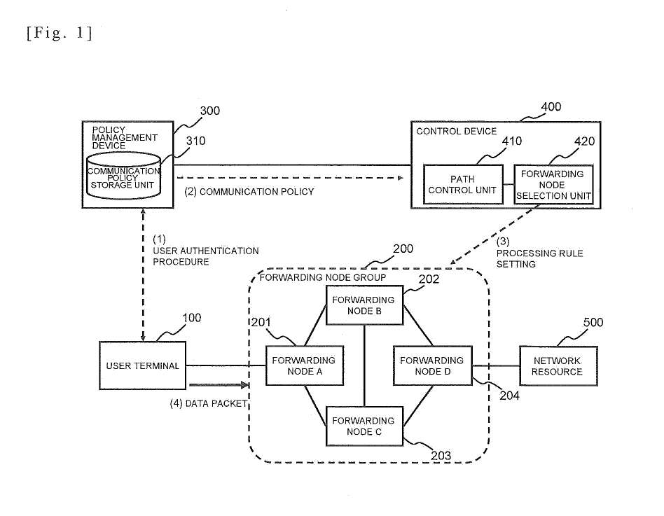

First, a description is given of an outline of an exemplary embodiment of the present disclosure, making reference to the drawings. It is to be noted that drawing reference symbols included in this outline are added for convenience to respective elements as an example in order to aid understanding and are not intended to limit the invention to modes of the drawings shown. The present disclosure, as shown in FIG. 1, can be realized by a configuration including: a forwarding node group 200 that processes a packet(s) transmitted from a user terminal 100 in accordance with a processing rule(s) that has been set by a control device 400, a policy management device 300 that manages communication policy and gives notification of a communication policy assigned to a user for whom authentication has succeeded, to the control device, and the control device 400 that creates a processing rule implementing whether or not access is allowed as far as a device (a network resource 500) that is an access destination from the user terminal 100, based on the communication policy notified from the policy management device 300, and sets the processing rule in question in the forwarding node group 200.

More specifically, the control device 400 is provided with a path control unit 410 that, with reception of a communication policy from the policy management device 300 as a trigger, creates a processing rule implementing whether or not access is allowed as far as the device (the network resource 500) that is an access destination from the user terminal 100, and a forwarding node selecting unit 420 that, with regard to a processing rule that can be set in a plurality of forwarding nodes of the forwarding node group 200, among processing rules created by the path control unit 410, selects a forwarding node to be set such that processing rules are not concentrated in a specific forwarding node based on the number of processing rules that are set in each forwarding node, and sets the processing rule in the forwarding node in question.

For example, in a case where access to the network resource 500 from the user terminal 100 is denied based on a communication policy notified from the policy management device 300, the control device 400 sets a processing rule to drop packets destined for the network resource 500 from the user terminal 100, in a forwarding node with fewer processing rules set, among forwarding node A and forwarding node D.

In the same way, for example, in a case where access to the network resource 500 from the user terminal 100 is allowed based on a communication policy notified from the policy management device 300, the control device 400 sets a packet forwarding path via a forwarding node with fewer processing rules set, among forwarding node B and forwarding node C, and sets a processing rule to forward a packet destined for the network resource 500 from the user terminal 100, in a forwarding node in the path in question.

From the above, it is possible to set a processing rule such that setting destinations of the processing rules are not biased to a node in one place.

It is to be noted that in the example of FIG. 1, the control device 400 sets a processing rule with reception of a communication policy from the policy management device 300 as a trigger, but creation and setting of a processing rule may be performed with a request for setting a processing rule from a forwarding node A201 or the like, which has received a packet from the user terminal 100, as a trigger. On this occasion, a configuration is also possible in which the control device 400 requests a communication policy for the user in question, with respect to the policy management device 300.

Furthermore, a period of validity may be provided in processing rule, and after the period of validity has passed from being set in forwarding nodes 201 to 204, or from reception of a final packet conforming with a matching rule, the processing rule in question may be deleted.

### First Exemplary Embodiment

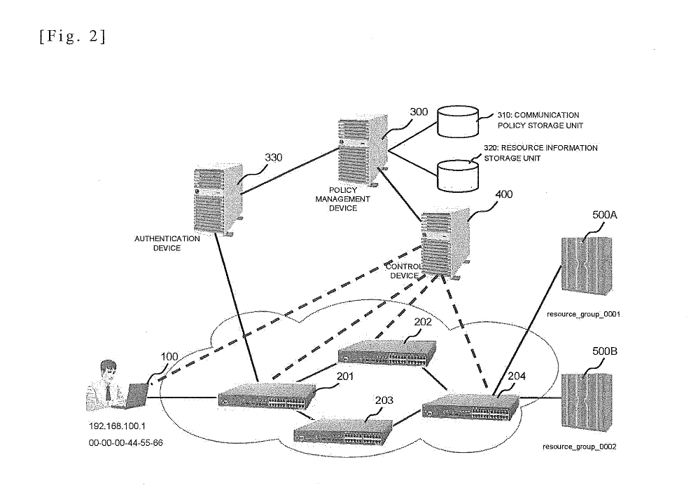

Next, a detailed description is given concerning a first exemplary embodiment of the present disclosure, making reference to the drawings. FIG. 2 is a diagram representing a configuration of a processing rule management system of a first exemplary embodiment of the invention. Referring to FIG. 2, a configuration is shown that includes a plurality of forwarding nodes 201 to 204, a control device 400 that sets a processing rule in the forwarding nodes, a policy management device 300 that notifies a communication policy to the control device 400, and an authentication device 330 that provides authentication information indicating an authentication result to the policy management device 300.

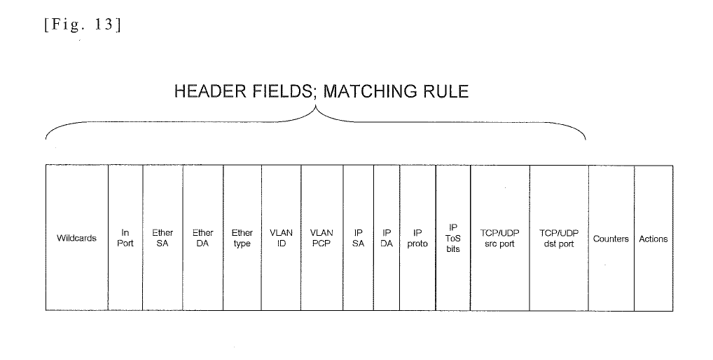

The forwarding nodes 201 to 204 are switching devices that process a received packet in accordance with a processing rule that associates a matching rule matching a received packet and processing content to be applied to a packet conforming with the matching rule. OpenFlow switches of Non-Patent Literature 2, which operate using a flow entry shown in FIG. 13 as a processing rule, can be used as these forwarding nodes 201 to 204.

Furthermore, network resources 500A and 500B are connected to the forwarding node 204, and a user terminal 100 can communicate with the network resources 500A and 500B via the forwarding nodes 201 to 204. In the following exemplary embodiment, the network resource 500A and the network resource 500B each belong to different resource groups, and resource_group_{—}0001 and resource_group_{—}0002 are assigned as respective resource group IDs.

The authentication device 330 is an authentication server or the like, that performs a user authentication procedure with the user terminal 100, using a password, biometric authentication information, or the like. The authentication device 330 transmits authentication information indicating a result of the user authentication procedure with the user terminal 100 to the policy management device 300.

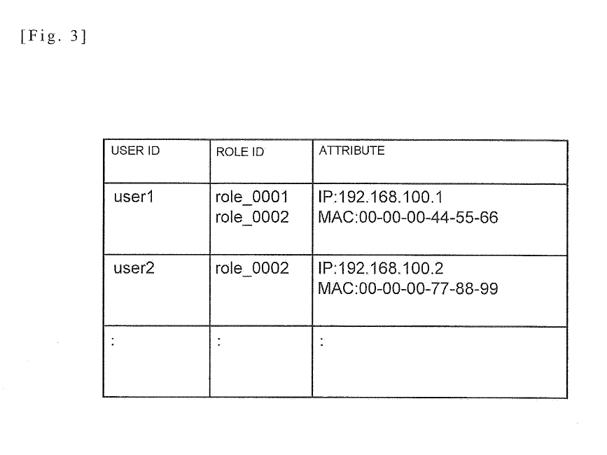

FIG. 3 is an example of authentication information held in the authentication device 330 in the present exemplary embodiment. For example, in a case of successful authentication of a user whose user ID is user1, the authentication device 330 transmits an entry for user1 of: attributes of user1, IP address: 192.168.100.1, and MAC address: 00-00-00-44-55-66, and role ID: role_{—}0001 and role_{—}0002, as authentication information to the policy management device 300. In the same way, in a case of successful authentication of a user whose user ID is user2, an entry for user2 of: attributes of user2, IP address: 192.168.100.2, and MAC address: 00-00-00-77-88-99, and role ID: role_{—}0002, are transmitted as authentication information to the policy management device 300.

It is to be noted that the authentication information is not limited to the example in FIG. 3, and may be information that enables determination of communication policy assigned to the user in question by the policy management device 300. For example, it is possible to use the user ID of a user for whom authentication has succeeded, a role ID derived from the user ID, an access ID such as a MAC address or the like, location information of the user terminal 100, or a combination of these, as the authentication information. Furthermore, information of a user for whom authentication has failed may be transmitted to the policy management device 300 as authentication information by the authentication device 330, and the policy management device 300 may transmit a communication policy restricting access from the user in question to the control device 400.

The policy management device 300 is connected to a communication policy storage unit 310 and a resource information storage unit 320, and is a device for determining a communication policy corresponding to authentication information received from the authentication device 330 and for transmitting to the control device 400.

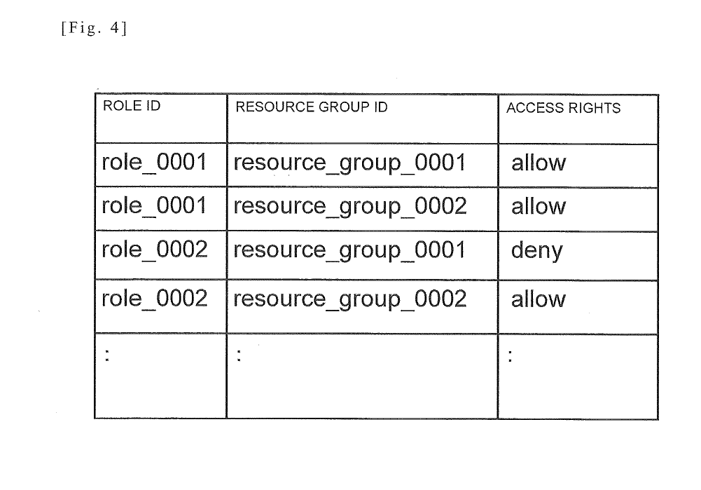

FIG. 4 is an example of communication policy information stored in the communication policy storage unit 310. The example in FIG. 4 shows resource group IDs assigned to groups of resources, and communication policy information that sets access rights, for each role distinguished by the role ID. For example, a user having the role ID: role_{—}0001 is allowed access to both resource groups having resource group ID: resource_group_{—}0001 and resource_group_{—}0002. On the other hand, a user having the role ID: role_{—}0002 is denied access to the resource group ID: resource_group_{—}0001 but is allowed access to resource_group_{—}0002.

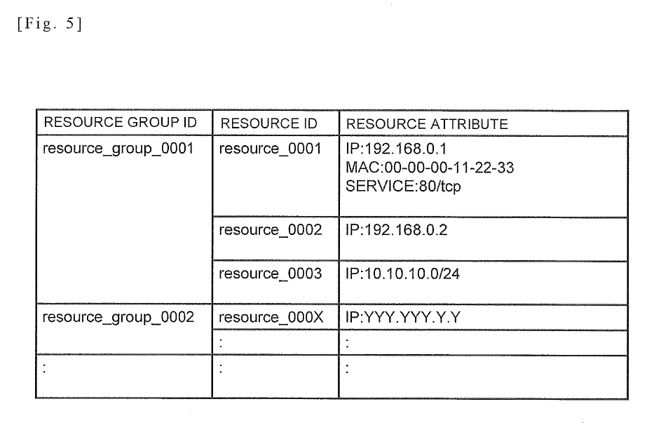

FIG. 5 is an example of resource information stored in the resource information storage unit 320. The example in FIG. 5 shows content associating resource IDs of resources belonging to the abovementioned resource group IDs and detailed attributes thereof. For example, in a group specified by resource group ID: resource_group_{—}0001, the resources: resource_{—}0001, resource_{—}0002, and resource_{—}0003 are included, and it is possible to identify respective IP addresses, MAC addresses, and port numbers used for services. Referring to the abovementioned communication policy information and the resource information, the policy management device 300 determines a communication policy for a user who has received authentication by the authentication device 330, and notifies the control device 400. For example, with a role ID included in authentication information received from the authentication device 330, the policy management device 300 can specify a resource group ID attached to the role ID in question and the content of access rights thereof, from the policy information in FIG. 4. Using information of a resource belonging to the resource group ID from the resource information in FIG. 5, the policy management device 300 creates a communication policy.

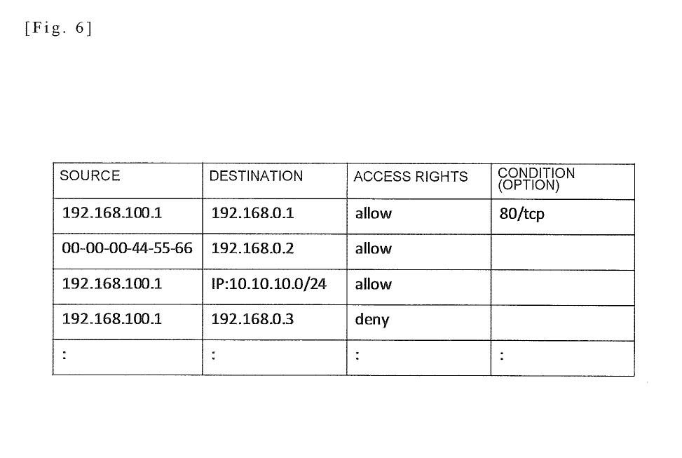

FIG. 6 shows communication polices for a user having the user ID: user1 created from the information shown in FIG. 3, FIG. 4, and FIG. 5. Attribute information values of the user ID: user1 in the authentication information in FIG. 3 are set in a source field in FIG. 6. Based on the content of role ID: role_{—}0001 of the policy information in FIG. 4, a resource attribute extracted from the resource information in FIG. 5 is set in a destination field. Furthermore, a value the same as the access rights of the role ID: role_{—}0001 of the policy information in FIG. 4 is set in an access rights field. Furthermore, a service and port number set in the resource attribute field of the resource information in FIG. 5 are set in the condition (option) field.

The control device 400 uses the communication policy as described above transmitted from the policy management device 300 to create a processing rule that implements an access range corresponding to the access rights assigned to a user, and sets a processing rule in a forwarding node.

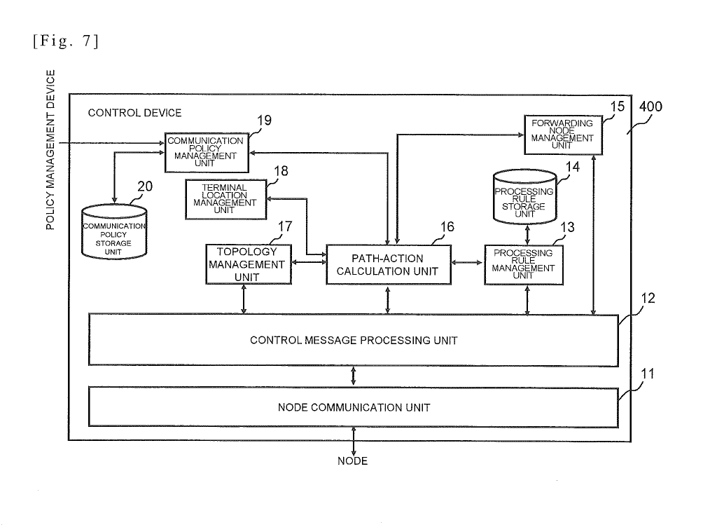

FIG. 7 is a block diagram representing a detailed configuration of the control device 400 of the present exemplary embodiment. Referring to FIG. 7, the control device 400 is configured by being provided with a node communication unit 11 that performs communication with the forwarding nodes 201 to 204, a control message processing unit 12, a processing rule management unit 13, a processing rule storage unit 14, a forwarding node management unit 15, a path-action calculation unit 16, a topology management unit 17, a terminal location management unit 18, a communication policy management unit 19, and a communication policy storage unit 20. These operate in the following respective ways.

The control message processing unit 12 analyzes a control message received from a forwarding node and delivers control message information to a relevant processing means inside the control device 400.

The processing rule management unit 13 manages what type of processing rule is set in which forwarding node. Specifically, a processing rule created by the path-action calculation unit 16 is registered in the processing rule storage unit 14 and set in a forwarding node, and registration information of the processing rule storage unit 14 is updated in response to a case where a change has occurred in a processing rule set in the forwarding node, by a processing rule deletion notification or the like from a forwarding node.

The forwarding node management unit 15 manages capability (for example, the number and type of ports, the type of actions supported, and the like) of forwarding nodes controlled by the control device 400. Furthermore, the forwarding node management unit 15 holds a threshold for selection of a setting destination of a processing rule that is set for each respective forwarding node.

The path-action calculation unit 16 operates as the abovementioned path control unit 410, and on receiving a communication policy from the communication policy management unit 19, first, refers to the network topology held by the topology management unit 17, in accordance with the communication policy in question, creates a path to a network resource in a range accessible by the user in question, and creates a processing rule implementing packet forwarding along the path. The path-action calculation unit 16 sets the created processing rule in a forwarding node in the path, via the processing rule management unit 13.

Specifically, based on location information of a user terminal managed by the terminal location management unit 18 and the network topology information constructed by the topology management unit 17, the path-action calculation unit 16 calculates a forwarding path for a packet. Next, the path-action calculation unit 16 obtains port information and the like of a forwarding node in the forwarding path from the forwarding node management unit 15, and requests an action to be executed in the forwarding node in the path for realizing the calculated forwarding path, and a matching rule for identifying flow in which the action is to be applied. It is to be noted that the matching rule can be created using a source IP address, a destination IP address, a condition (option) or the like of the communication policy in FIG. 6. Accordingly, in a case of the first entry of the communication policy in FIG. 6, for a packet with a source of the IP address 192.168.100.1 to a destination IP address 192.168.0.1, respective processing rules are created to determine a forwarding node that is a next hop and an action for forwarding from a port to which the network resources 500A and 500B are connected. It is to be noted that before setting the abovementioned processing rule, setting may be performed of only a processing rule allowing a request to set a processing rule with regard to the control device 400, and thereafter, a processing rule may be created to realize packet forwarding to a resource for which the user terminal has access rights.

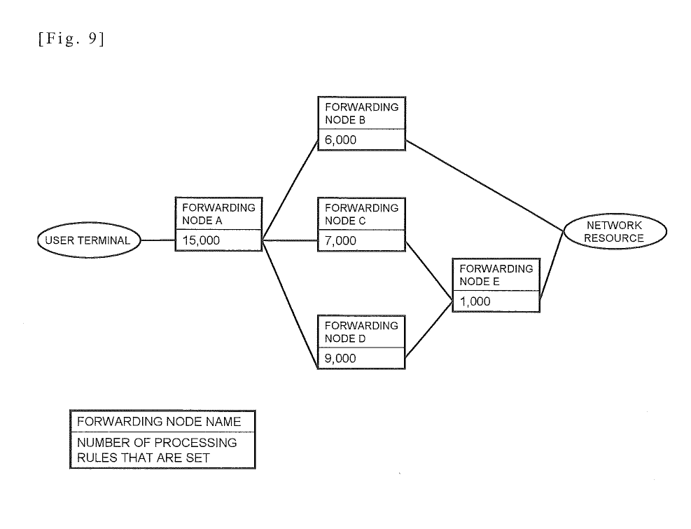

Moreover, the path-action calculation unit 16 of the present exemplary embodiment operates as the forwarding node selection unit 420 described above, and, for a processing rule that does not need to be set in a specific forwarding node among the created processing rules, namely, for a processing rule that can be set in a plurality of forwarding nodes, a setting destination of the processing rule in question is selected. Specifically, the path-action calculation unit 16 selects a forwarding node where a processing rule is to be set, such that processing rules are not concentrated in a specific forwarding node, based on distance from the user terminal and the number of processing rule set in each forwarding node, and sets the processing rule via the processing rule management unit 13, in the selected forwarding node. A specific example thereof is described later, making reference to FIG. 9 to FIG. 11.

The topology management unit 17 constructs network topology information based on connection relationships of the forwarding nodes 201 to 204 collected via the node communication unit 11.

The terminal location management unit 18 manages information for identifying the location of a user terminal connected to a communication system. In the present exemplary embodiment, a description is given using an IP address as information for distinguishing a user terminal, and a forwarding node identifier of a forwarding node to which the user terminal is connected and information of a port thereof, as information for identifying the location of the user terminal. Clearly, instead of this information, information provided by the authentication device 330, for example, may be used to identify a terminal and its location.

On receiving the communication policy information from the policy management device 300, the communication policy management unit 19 stores the information in the communication policy storage unit 20, and transmits to the path-action calculation unit 16.

The control device 400 as described above can also be realized by adding a creation function for a processing rule (flow entry) and a selection function for a setting destination (forwarding node) of a processing rule, with reception of the abovementioned communication policy as a trigger, based on an OpenFlow controller of Non-Patent Literatures 1 and 2.

It is to be noted that respective parts (processing means) of the control device 400 shown in FIG. 7 can be realized by a computer program that stores the abovementioned respective information and executes the respective processes described above in a computer that configures the control device 400, using hardware thereof.

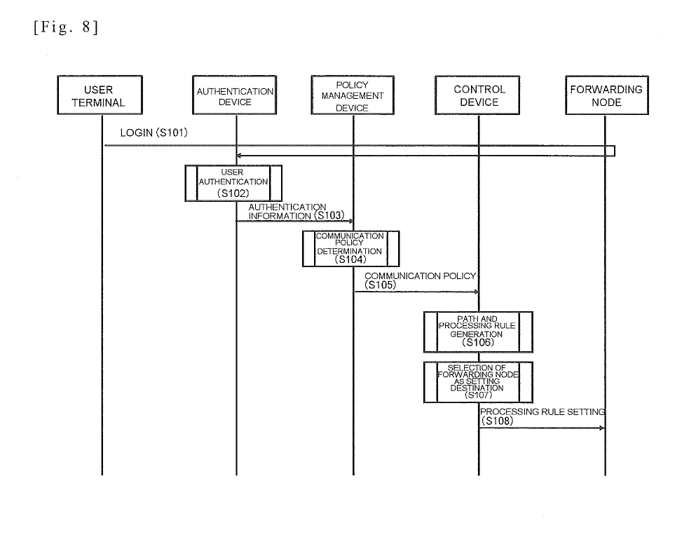

Next, a detailed description is given concerning operations of the present exemplary embodiment, making reference to the drawings. FIG. 8 is a sequence diagram representing a sequence of operations of the present exemplary embodiment. Referring to FIG. 8, first, when the user terminal makes a login request to the authentication device 330, packet forwarding is performed to the authentication device 330 (S101 in FIG. 8). The authentication device 330 performs user authentication (S102 in FIG. 8), and transmits authentication information of the user terminal to the policy management device 300 (S103 in FIG. 8).

The policy management device 300 refers to the communication policy storage unit 310 and the resource information storage unit 320 based on received authentication information, to determine a communication policy (S104 in FIG. 8) and transmits a result thereof to the control device 400 (S105 in FIG. 8). The control device 400 creates a path and a processing rule between the user terminal and a network resource based on the communication policy of the user terminal, notified from the policy management device 300 (S106 in FIG. 8).

In addition, with regard to a processing rule that can be set in a plurality of forwarding nodes, among the generated processing rules, the control device 400 selects a forwarding node as a setting destination (S107 in FIG. 8) and sets the processing rule in the forwarding node in question (S108 in FIG. 8).

Thereafter, when the user terminal 100 transmits a packet to the forwarding node where the processing rule is set, respective forwarding nodes make a judgment regarding packet forwarding in accordance with the processing rule set by the control device 400. In a case where access is allowed to a network resource, the forwarding node forwards the packet to the network resource in question. On the other hand, in a case where access to the network resource is denied in accordance with the set processing rule, the forwarding node drops the packet in question (not shown in FIG. 8).

Here, a detailed description is given concerning processing to select a forwarding node as a setting destination of a processing rule in the abovementioned step S107, making reference to the drawings. In addition, in the following, a description is given citing an example of selecting a setting destination of a processing rule that drops a packet from the user terminal 100, from among forwarding nodes A to E that are connected as shown in FIG. 9, based on the communication policy notified from the policy management device 300.

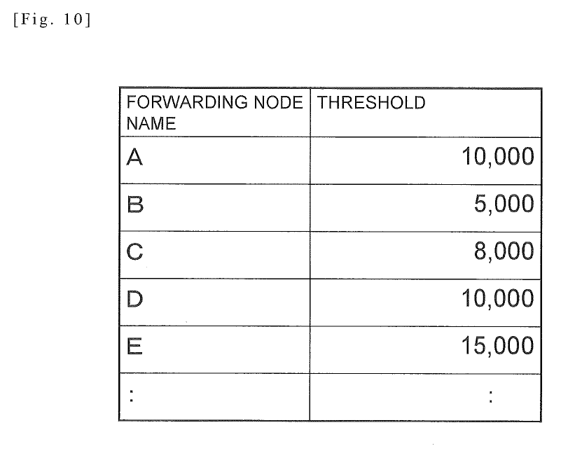

FIG. 10 shows an example of thresholds for selection of a setting destination of a processing rule for each respective forwarding node held in the forwarding node management unit 15. Referring to FIG. 10, “10,000” is set as a threshold in forwarding node A. In this case, when the number of processing rules held by the forwarding node A is greater than or equal to 10,000, the forwarding node A is excluded from setting destinations of the processing rule. In addition, with regard to the respective thresholds, the maximum number of processing rules in specifications of the respective forwarding nodes or a recommended number of processing rules may be set as a reference, or a threshold may be dynamically modified in accordance with forwarding node load. Furthermore, a mechanism is also possible whereby thresholds set in the respective forwarding nodes and methods of determining these can be freely set at any timing by a user.

Next, a description is given of flow in which the path-action calculation unit 16 that operates as the forwarding node selection unit 420 selects a setting destination of a processing rule, from among the forwarding nodes A to E shown in FIG. 9, up to selecting a processing rule.

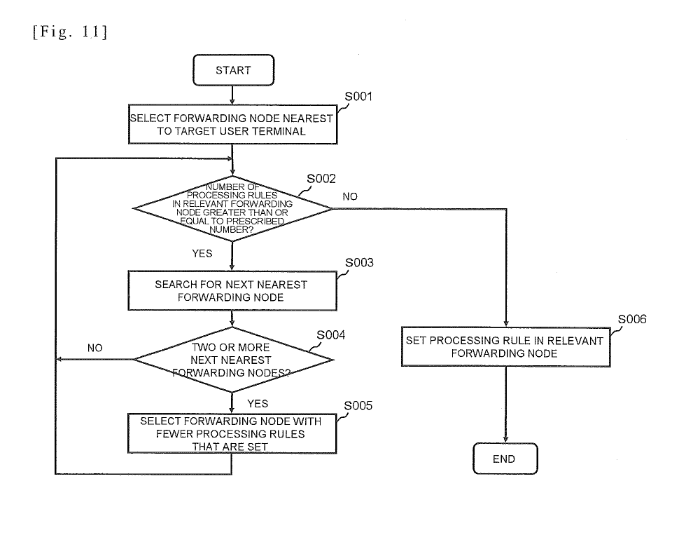

FIG. 11 is a flowchart showing flow up to where a processing rule that drops a packet from a certain user terminal 100 to a network resource is set, by the path-action calculation unit 16.

Referring to FIG. 11, when the path-action calculation unit 16 generates a processing rule to drop a packet from a certain user terminal 100 to a network resource, first it selects a forwarding node nearest to the user terminal 100 (S001 in FIG. 11) as a setting destination of the processing rule in question. For example, in the example of FIG. 9 the forwarding node A that is nearest to the user terminal 100 is selected from among the forwarding nodes A to E. Here, “near” indicates that the distance from the user terminal 100 to the forwarding node is short (a small number of hops) in comparison to the distance from other forwarding nodes or a prescribed threshold, but besides this, the zone of each link, traffic state, or the like may be considered.

Next, the path-action calculation unit 16 confirms whether or not the number of processing rules currently set in a selected forwarding node is greater than or equal to a fixed threshold for the forwarding node in question (S002 in FIG. 11). Here, in a case where the number of processing rules currently set in the forwarding node in question is less than the threshold (NO in 5002 in FIG. 11), the processing rule is set in the forwarding node A (S006 in FIG. 11).

On the other hand, in a case where the number of processing rules currently set in the selected forwarding node is greater than or equal to the threshold (YES in S002 in FIG. 11), the path-action calculation unit 16 searches for forwarding nodes nearest to the user terminal 100 after the selected forwarding node (S003 in FIG. 11) and determines whether or not there are two or more of these forwarding nodes (S004 in FIG. 11). In the example of FIG. 9, the number of processing rules currently set in the forwarding node A is “15,000” and the threshold of the forwarding node A in FIG. 10 is 10,000 or greater. In this case, forwarding nodes B to D, as forwarding nodes that are the next nearest to the user terminal 100, are selected as next setting destination candidates for the processing rule.

In a case where there is one forwarding node selected in the search, the path-action calculation unit 16 returns to step S002 and compares the number of processing rules currently set in the forwarding nodes in question, and the threshold of the forwarding nodes (NO in step S004).

On the other hand, in a case where there are two or more forwarding nodes selected in the search (YES in step S004), the path-action calculation unit 16 selects the forwarding node with fewer processing rules currently set (step S005), returns to step S002, and compares the number of processing rules currently set in the forwarding nodes in question and the threshold of the forwarding nodes (to step S002).

In the example of FIG. 9, next to the forwarding node A, the forwarding nodes B to D are retrieved as forwarding nodes near to the user terminal 100. Among them, since the forwarding node with the fewest processing rules currently set is forwarding node B, in step S005 forwarding node B is selected. In step S002 the second time, a comparison is made of the number, 6000, of processing rules currently set in the forwarding node B, and the threshold, 5000, of the forwarding node B in FIG. 10.

However, since the number of processing rules is greater than or equal to the threshold in FIG. 10 for the forwarding node B also, processing advances to step S003, and the forwarding nodes C and D are retrieved as forwarding nodes near to the user terminal 100, next to the forwarding node B. Among the forwarding nodes C and D, since the forwarding node with the fewest processing rules currently set is forwarding node C, in step S005 the forwarding node C is selected. In step S002 the third time, a comparison is made of the number, 7000, of processing rules currently set in the forwarding node C, and the threshold, 8000, of the forwarding node C in FIG. 10.

As a result of the comparison, since the number of processing rules set in forwarding node C is less than the threshold in FIG. 10 (NO in S002), forwarding node C is selected for setting the processing rule, and the processing rule is set in step S006.

As described above, each time a communication policy of each user is notified, the path-action calculation unit 16 creates a processing rule implementing the communication policy in question, and selects among these, a setting destination of a processing rule that drops a packet from the user in question. In this way, for example, from among the plural forwarding nodes of FIG. 9, it is possible to dispose a processing rule in a forwarding node (for example, forwarding node C in FIG. 9) that is nearest to the user terminal and in which the number of processing rules that are set is less than a prescribed threshold.

In this way, according to the present exemplary embodiment it is possible to prevent processing rules from being set in a concentrated fashion in a specific forwarding node. Thus, it is possible to prevent a problem such as where processing load in a specific forwarding node becomes too large.

Furthermore, a description has been given in which, in step S005 of the flowchart of FIG. 11, a forwarding node with fewer processing rules set is selected, but it is also possible to select a forwarding node with a large available capacity for setting processing rules. The available capacity for setting processing rules can be obtained, for example, from the difference between the maximum number of processing rules that can be set in the forwarding node in question and the number of processing rules actually set therein.

### Second Exemplary Embodiment

Next, a description is given concerning a second exemplary embodiment of the present disclosure in which a setting destination of a processing rule is selected giving consideration not only to the number of processing rules that are set in each forwarding node, but also to a load thereon. Since the second exemplary embodiment of the invention as below can be realized by a configuration approximately the same as the first exemplary embodiment described above, the description below is centered on points of difference therefrom.

A forwarding node management unit 15 of a control device of the present exemplary embodiment holds load states reported from each forwarding node, and a path-action calculation unit 16 refers to the load state of each of these forwarding nodes to select a setting destination of a processing rule. It is to be noted that with regard to the load state of each forwarding node, a load state measuring unit may be provided and a report made at prescribed time intervals, or a control device 400 may provide an estimate from the capability of each forwarding node or traffic volume flowing in each forwarding node.

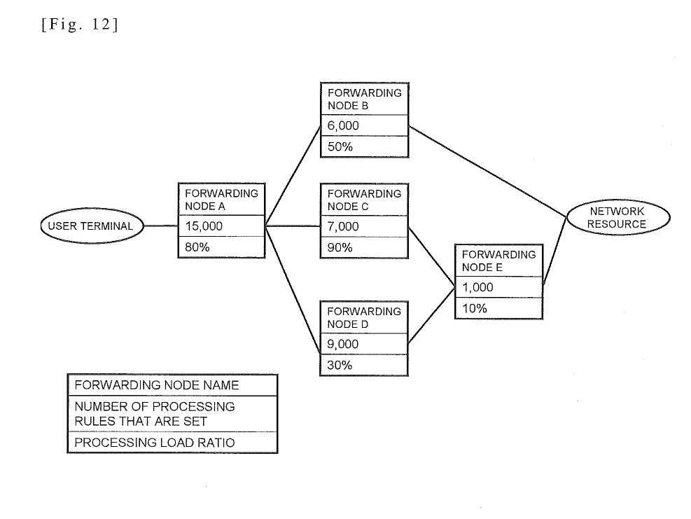

For example, a case is considered in which the number of processing rules currently set in forwarding nodes A to E, and the load state (processing load ratio) are obtained, as in FIG. 12. In the first exemplary embodiment described above, the path-action calculation unit 16 selects in the order of forwarding node A, B, and C, and finally selects the forwarding node C as a setting destination. However, in a case where the processing load ratio of the forwarding node C is high (in comparison to a prescribed threshold) as at 90%, as in FIG. 12, the path-action calculation unit 16 may select as a setting destination of processing rule, the forwarding node D where the number of processing rules that are set is less than the threshold of FIG. 10 (9,000<threshold 10,000), and (in comparison to the prescribed threshold) the processing load ratio is low (30%).

By having this situation, it is possible to select a setting destination of the processing rule, giving consideration not only to simply the number of processing rules that are set, but also the load state of each of the forwarding nodes.

Descriptions have been given above of respective exemplary embodiments of the present disclosure, but the present disclosure is not limited to the abovementioned exemplary embodiments, and further modifications, substitutions, and adjustments may be added within a scope that does not depart from a fundamental technical concept of the present disclosure. For example, in the abovementioned exemplary embodiments a description was given in which the control device 400, the authentication device 330, the policy management device 300, the communication policy storage unit 310, and the resource information storage unit 320 are each provided independently, but it is also possible to use a configuration in which these are integrated as appropriate.

In addition, in the abovementioned exemplary embodiments a description was given in which access control is performed by assigning a role ID to a user as shown in FIG. 3 to FIG. 6, but it is also possible to perform access control using a user ID assigned to each user, an access ID such as a MAC address, location information of the user terminal 100, or the like.

Furthermore, in the abovementioned exemplary embodiments a description was given in which the user terminal 100 performs an authentication procedure with the authentication device 330 via the forwarding node 200, but it is also possible to use a configuration in which the user terminal 100 communicates directly with the authentication device 330 to implement an authentication procedure. In this case, creation and setting of a processing rule may be performed, with a request for setting the processing rule from the forwarding node 201 or the like, which has received a packet from the user terminal 100, as a trigger. On this occasion, a configuration is also possible in which the control device 400 requests a communication policy for the user in question, with respect to the policy management device 300.

In each of the abovementioned exemplary embodiments a description was given in which a threshold for selection of a setting destination of a processing rule is held in the forwarding node management unit 15, but a configuration is also possible in which a threshold for selection of a setting destination of a processing rule is stored in another device (for example, a setting information storage device or the like), and the control device 400 receives the a threshold for selection of a setting destination of the processing rule from the setting information storage device and selects a forwarding destination node based on this.

Furthermore, in each of the abovementioned exemplary embodiments a description was given in which a threshold is set for each forwarding node, but in a situation where there is little variation in capability of the respective forwarding nodes, a common threshold may be applied to all the forwarding nodes.

In each of the abovementioned exemplary embodiments, a description was given in which, first, the control device 400 sets a processing rule giving priority to a forwarding node nearest to the user terminal 100, but it is also possible to use a setting destination selection rule for a setting destination of a processing rule giving priority to a forwarding node with the fewest processing rules set, or a setting destination selection rule for a setting destination of a processing rule giving priority to a forwarding node with the least load. In the example of FIG. 9, for example, the forwarding node E that has fewest processing rules may be selected as a setting destination of a processing rule. In the same way, in the example of FIG. 12, the forwarding node E in which the processing load ratio is lowest may be selected as a setting destination of a processing rule. Since the processing load ratio of a forwarding node changes moment by moment, the control device 400 constantly monitors the processing load ratio of each forwarding node, and at a point in time when it becomes necessary to select a forwarding node as a setting destination of a processing rule, a processing rule may be set in a forwarding node having the lowest processing load ratio. Furthermore, the control device 400 may select the setting destination of a processing rule, giving consideration to both the number of processing rules and the processing load ratio.

In the abovementioned exemplary embodiments a description was given in which a processing rule for dropping a packet to a certain network resource from a certain user terminal 100 is set in the selected forwarding node, but a similar processing rule may also be set in a forwarding node to which there is a possibility of another user terminal 100 being connected.

The control device 400 may use a setting destination selection rule so as to select a setting destination of a processing rule such that the number of processing rules set in each forwarding node is equalized. In the example of FIG. 9, the average of the number of processing rules that are set in each of the forwarding nodes is calculated as

15,000+6,000+7,000+9,000+1,000/5≈7,600

As a setting destination of a processing rule, a selection may be made of the forwarding node B or C, or the forwarding node E, in which the number of processing rules that are set is less than the average.

Furthermore, the control device 400 may transfer some processing rules registered in the forwarding nodes A and D, in which the number of processing rules currently set is larger than the average, to the forwarding nodes B, C, and E. In this way, it is possible to equalize the number of processing rules held in the respective forwarding nodes.

For example, as a setting destination of the processing rule, the control device 400 may use a setting destination selection rule that makes a selection giving priority to a forwarding node in the shortest path between the user terminal and a device that is an access destination. In the example of FIG. 9, the shortest path between the user terminal and the network resource is “user terminal to forwarding node A to forwarding node B to network resource”, and the processing rule is set having priority with respect to either the forwarding node A or the forwarding node B.

The control device 400 may set a processing rule (a processing rule for dropping a packet to the network resource from the user terminal) that denies access to both the forwarding node A and the forwarding node B in the abovementioned shortest path. In this way, by setting a processing rule to deny access to a plurality of forwarding nodes going between the user terminal and the network resource, it is possible to realize more strict access control.

Furthermore, for example, the control device 400 may use a setting destination selection rule to set a processing rule in a forwarding node that is nearest to any forwarding node in the shortest path between the user terminal and the network resource, and that has the least number of processing rules set. In the example of FIG. 9, the shortest path between the user terminal and the network resource is “user terminal to forwarding node A to forwarding node B to network resource”, and the forwarding nodes that are nearest to any forwarding node in the shortest path in question are the forwarding node C and the forwarding node D. A forwarding node with the least number of processing rules set, among the forwarding node C and the forwarding node D, is the forwarding node C (the number of processing rules is 7,000). In this case, the control device 400 sets the processing rule in the forwarding node C. By arranging in this way, in a case where some fault occurs in the shortest path between the user terminal and the network resource, control is implemented to deny access to a forwarding node in a detour path also, and it is possible to realize a more robust security strategy.

In addition, the user can give an instruction to the control device 400 to freely select, or to combine, various types of setting destination selection rules for processing rules, as described above.

It is to be noted that that each disclosure of the abovementioned Patent Literature and non-Patent Literatures is incorporated herein by reference thereto. Modifications and adjustments of exemplary embodiments are possible within the bounds of the entire disclosure (including the scope of the claims) of the present disclosure, based on fundamental technological concepts thereof. Furthermore, a wide variety of combinations and selections of various disclosed elements is possible within the scope of the claims of the present disclosure. That is, the present disclosure clearly includes every type of transformation and modification that a person skilled in the art can realize according to the entire disclosure including the scope of the claims and to technological concepts thereof.

### REFERENCE SIGNS LIST

11 node communication unit
12 control message processing unit
13 processing rule management unit
14 processing rule storage unit
15 forwarding node management unit
16 path-action calculation unit
17 topology management unit
18 terminal location management unit
19 communication policy management unit
20 communication policy storage unit
100 user terminal
200, 201, 202, 203, 204 forwarding node
300 policy management device
310 communication policy storage unit
320 resource information storage unit
330 authentication device
400 control device
410 path control unit
420 forwarding node selection unit
500, 500A, 500B network resource

What is claimed is:

1. A communication system, comprising:
a plurality of forwarding nodes that process a packet(s) transmitted from a user terminal, in accordance with a processing
rule(s) that has been set; and
at least one control apparatus which, when a processing rule that can be set in any among said plurality of forwarding nodes is set, selects a forwarding node in which said processing rule is to be set, from among said plurality of forwarding nodes, such that processing rules are not concentrated in a specific forwarding node, based on the number of processing rules set in each of said forwarding nodes.

2. The communication system according to claim 1, wherein said control apparatus selects a setting destination for said processing rule, giving priority to a forwarding node connected near to said user terminal or a forwarding node with the least number of processing rules that are set.

3. The communication system according to claim 1, wherein said control apparatus excludes a forwarding node in which the number of processing rules that are set is greater than or equal to a threshold, from a setting destination of said processing rule.

4. The communication system according to claim 3, wherein said prescribed threshold can be set in each of said forwarding nodes.

5. The communication system according to claim 1, wherein, in a case where there is a plurality of forwarding nodes that are destination candidates for setting of said processing rule, said control apparatus sets said processing rule in a forwarding node with the largest available capacity for setting processing rules, among said plurality of processing rules.

6. The communication system according to claim 1, wherein said control apparatus selects a setting destination for said processing rule, giving priority to a forwarding node with the least number of processing rules that are set, among forwarding nodes connected near to said user terminal.

7. The communication system according to claim 1, wherein said control apparatus further comprises a unit that comprehends a load state of each of said forwarding nodes, and excludes a forwarding node with a high load from setting destinations of said processing rule.

8. The communication system according to claim 1, wherein said control apparatus further comprises a unit that comprehends a load state of each of said forwarding nodes, and gives priority to a forwarding node with a low load in making a selection of a setting destination of said processing rule.

9. The communication system according to claim 1, wherein said control apparatus further calculates an average of the number of processing rules that are set in said respective forwarding nodes, and selects a forwarding node in which the number of processing rules that are set is less than said average, to set a processing rule.

10. The communication system according to claim 1, wherein said control apparatus further calculates an average of the number of processing rules that are set in said respective forwarding nodes, and transfers a processing rule of a forwarding node in which the number of processing rules that are set is more than said average, to a forwarding node in which the number of processing rules that are set is less than said average.

11. The communication system according to claim 1, further comprising a policy management apparatus that manages communication policy and gives notification of a communication policy corresponding to a user for whom authentication has succeeded, to a control apparatus, wherein
the control apparatus, based on said communication policy notified from said policy management apparatus, sets a processing rule in any forwarding node in the shortest path between said user terminal and a resource that is accessible by said user, a plurality of forwarding nodes in the shortest path, or all forwarding nodes in the shortest path.

12. The communication system according to claim 11, wherein said control apparatus further sets a processing rule that drops a packet to a destination for which access is denied, transmitted from said user terminal, in a forwarding node in the shortest path, said forwarding node being nearest to said user terminal and in which the number of processing rules that are set is less that a prescribed threshold.

13. The communication system according to claim 1, wherein said control apparatus selects a forwarding node in which said processing rule is to be set, based on a rule for selecting a setting destination of said processing rule that has been specified by a user.

14. A control apparatus, adapted to be connected to a plurality of forwarding nodes that process a packet(s) transmitted from a user terminal, in accordance with a processing rule(s) that has been set, wherein
when a processing rule(s) that can be set in any among said plurality of forwarding nodes is set, a selection is made of a forwarding node(s) in which said processing rule is to be set, from among said plurality of forwarding nodes, such that processing rules are not concentrated in a specific forwarding node(s), based on the number of processing rules that are set in said respective forwarding nodes.

15. A processing rule setting method by a control apparatus adapted to be connected to a plurality of forwarding nodes that process a packet(s) transmitted from a user terminal, in accordance with a processing rule(s) that has been set, comprising:
confirming the number of processing rules that are set in said respective forwarding nodes, when a processing rule that can be set in any among said plurality of forwarding nodes is set; and
selecting a forwarding node in which said processing rule(s) is to be set, from among said plurality of forwarding nodes, such that processing rules are not concentrated in a specific forwarding node(s), based on the number of processing rules that are set in said respective forwarding nodes, and setting said processing rule in said forwarding node(s).

16. (canceled)

17. The control apparatus according to claim 14, wherein said control apparatus selects a setting destination for said processing rule, giving priority to a forwarding node connected near to said user terminal or a forwarding node with the least number of processing rules that are set.

18. The control apparatus according to claim 14, wherein said control apparatus excludes a forwarding node in which the number of processing rules that are set is greater than or equal to a threshold, from a setting destination of said processing rule.

19. The control apparatus according to claim 18, wherein said prescribed threshold can be set in each of said forwarding nodes.

20. The control apparatus according to claim 14, wherein, in a case where there is a plurality of forwarding nodes that are destination candidates for setting of said processing rule, said control apparatus sets said processing rule in a forwarding node with the largest available capacity for setting processing rules, among said plurality of processing rules.

21. The control apparatus according to claim 14, wherein said control apparatus selects a setting destination for said processing rule, giving priority to a forwarding node with the least number of processing rules that are set, among forwarding nodes connected near said user terminal.
